(19) United States
(12) Patent Application Publication
(10) Pub. No.: US 2026/0275690 A1
(43) Pub. Date: Sep. 17, 2026

(54) APPARATUS AND METHOD CORRELATED THEREWITH FOR PRODUCING WATER BY MEANS OF A VAPOR CONVECTION TYPE SOLAR RECEIVER

(71) Applicant: AKUA S.R.L., Zane' (VI) (IT)

(72) Inventors: Massimo VICENTINI, Camisano Vicentino (VI) (IT); Giovanni RONDA, Thiene (VI) (IT)

(73) Assignee: AKUA S.R.L., Zane' (VI) (IT)

(21) Appl. No.: 19/472,679

(22) PCT Filed: Apr. 5, 2024
(86) PCT No.: PCT/IB2024/053352

§ 371 Date: Oct. 5, 2025

(30) Foreign Application Priority Data
Apr. 5, 2023 (IT) 102023000006699

(51) Int. Cl. E03B 3/28; F24S 20/20; F24S 23/74; F24S 50/20; F24S 70/225

(52) U.S. Cl. CPC E03B 3/28; F24S 20/20; F24S 23/74; F24S 50/20; F24S 70/225; F24S 2020/23

(57) ABSTRACT

A solar receiver for producing water from ambient humidity includes a thermal absorber in the region of a focusing axis and a casing which is transparent and concentric with respect to the thermal absorber. The absorber contains drying material which allows adsorption of humidity contained in the air and the desorption of the water vapor. The solar receiver also includes intake and emission valves connecting the thermal absorber to the external environment and a circuit which fluid-dynamically connects the thermal absorber to the casing. Humid air is directed, by a fan, inside the thermal absorber and, once the drying material is saturated, the valves are closed and the air inside the casing and the thermal absorber is heated. Once the optimum temperature is reached, the fan is activated in order to enable desorption of the water from the drying material and to collect the condensate and water in a condenser.

### CROSS REFERENCE TO RELATED APPLICATIONS

This application is a § 371 National Phase of PCT/US 2024/053352, filed Apr. 5, 2024, which claims priority of Italian Patent Application Number 102023000006699, filed Apr. 5, 2023, the entire contents of all of which are incorporated by reference herein as if fully set forth.

### FIELD OF THE INVENTION

The present invention relates to a convection type solar receiver, an apparatus comprising the solar receiver and a method for producing water from the air humidity.

### BACKGROUND

The convection type solar receiver is also referred to simply as a solar receiver.

In a context of increasing global aridity, there are warnings about the need to find new strategies for providing water, particularly in all the desert zones of the planet.

The possibility and capacity for obtaining and preserving water reserves is increasingly becoming a key parameter for defining living conditions of a predetermined environmental zone.

Furthermore, as a result of the continuous demographic increase which is being recorded on our planet, there is identified an increasing need for making habitable zones which were previously inhabitable or inhospitable because they do not have the most essential resources, including water (for example, deserts). Given this global water need, there have been developed different innovative and economical solutions which are directed towards obtaining water, in some cases drinking water, from the humidity of the environment.

An example of technology for extracting humidity from the air is described in the international patent WO 2016/086751 A1, which relates to an apparatus for absorbing humidity from the air using hygroscopic materials and solar collectors. Some embodiments of the invention provide only the phase of desorption inside the device, involving the intervention of an operator who positions the absorbent portion outside the device in the phase of adsorption of the humidity in order then to insert it inside the device in the desorption phase.

Disadvantageously, the method described becomes very laborious from the point of view of the use of dedicated resources, which are not always available in the zones in which these types of devices have the greatest efficiency (desert zones). Other embodiments provide both for the phase of adsorption and for the phase of desorption inside the device, but with mechanical configurations which are quite elaborate.

Another technological example appears in the German patent DE 10 2010 004195 A1 which relates to a solar generator for generating electrical energy which also uses solar irradiation for generating water from the atmospheric humidity. As can be seen in the description, the main object of this device is not the object of generating water, but instead of producing energy and therefore it is not optimized for this first object. In fact, it does not provide for fans and valves for controlling the air flows in the different daily phases.

In the Chinese Utility Model CN 2 218 770 Y, the device for producing water from the atmosphere is very simple and involves a solar collector which is configured as if it were a solar panel which is filled with hygroscopic material. The collector provides for an opening for the circulation of the air and a condenser which is controlled by a valve and in which the condensate is deposited. In this case, there are also not provided any fans or fluid-dynamic circuits which provide for the forced alternation of warm air or cold air, but instead rely on the prevailing meteorological condition. The invention pays the price for of the technological simplicity thereof by being suitable as an emergency device but only being suitable with difficulty for producing water quantities which are adequate for complying with the need for water of a potential family or village in arid zones.

Finally, the Utility Model CN 209 144 913 U relates to a device for producing humidity from the air but with a plurality of collectors in parallel, which are heated by respective reflective surfaces. In this case, fans which optimize the flows of air are also not provided.

In general, many of the technologies which are set out provide for supplying electromechanical components through solar panels which are integrated in the system.

A technological disadvantage of a number of these inventions is the need for using a vacuum pump system which allows, by means of a slight reduced pressure, the dew point of the evaporated water to be reduced, thereby allowing the condensation thereof.

Again, another disadvantage is that these systems can have dimensions which are extensive and bulky, making the installation thereof complex and disadvantageous in terms of space.

Therefore, the problem addressed by the present invention is to provide a convection type solar receiver, a respective apparatus and method for producing water from the atmospheric humidity which allows one or more of the disadvantages set out with reference to the cited prior art to be overcome.

### SUMMARY

An object of the present invention is to provide a convection type solar receiver which allows the quantities of water desired to be obtained via a forced air and/or vapor ventilation system with optimized condensation, being able to provide effective adsorption and desorption of environmental water, preferably in a simple manner in accordance with desired time cycles which can be adapted to variable necessities.

An object of the invention is also to provide a convection type solar receiver which achieves the above object and which is easy to construct, has small dimensions and is economical.

Another object is to provide a convection type solar receiver which provides for the production of water vapor both via convection and via irradiation.

In particular, in a first aspect of the invention, this problem is solved and these objects are achieved by an apparatus for producing water from atmospheric humidity, comprising a convection type solar receiver which has one or more of the features discussed below.

According to a first aspect, the present invention also relates to a convection type solar receiver for producing water from ambient humidity, comprising:
a frame;
a reflective surface which is configured to reflect solar radiation and which is fixed to the frame; the reflective surface having a focusing axis for the incident solar radiation;
a thermal absorber which is positioned substantially in the region of the focusing axis; the thermal absorber comprising an intake end and an emission end;
a casing which is concentric with respect to the thermal absorber and which is transparent to solar radiation, the casing extending between the intake end and the emission end and being partially in communication in fluid-dynamic terms with the thermal absorber near the emission end, the thermal absorber being contained in the casing;
an intake valve which connects the thermal absorber to the external environment through a respective intake opening which opens from the casing and the frame;
an emission valve which connects the thermal absorber to the external environment through a respective emission opening which opens from the casing and the frame;
a condenser which is connected to the casing in the region of a concentric intake end thereof;
a drying material which is arranged inside the thermal absorber;
a device for the forced circulation of air which is positioned between the intake end and the intake valve, the device for the forced circulation of air being configured so as to generate an incoming air current and/or an outgoing air current into/from the thermal absorber;
the valves being selectively actuatable from a closed configuration to an open configuration, and vice versa, so as to allow in a selective and reversible manner the fluid-dynamic connection between the drying material and surrounding humid air or between the drying material and warm air and/or vapor which are contained in the thermal absorber so as to enable an adsorption cycle of the humidity by the drying material and a desorption cycle of water vapor from the drying material.

According to yet another aspect, the present invention also relates to a method for producing water from the ambient humidity having one or more of the features discussed below.

According to another aspect, the present invention also relates to a method for producing water from the ambient humidity by means of a convection type solar receiver and the respective apparatus, comprising:
a) opening an intake valve and an emission valve of a thermal absorber which is fixedly joined to a frame of the solar receiver;
b) carrying out an air circulation so as to circulate humid air which is present in the surrounding environment inside the thermal absorber which in turn comprises drying material which is capable of absorbing humidity;
c) carrying out a first measurement of one or more parameters which are selected from temperature, humidity, weight, temperature difference, humidity difference, weight difference;
d) when one or more of the parameters reaches a first predetermined threshold, closing the intake valve and the emission valve, generating a fluid-dynamically closed circuit between the thermal absorber and the casing;
e) preferably interrupting the circulation of the air;
f) heating the air which is contained in the thermal absorber and in the casing by means of a reflective surface which is contained in the solar receiver;
g) carrying out a second measurement of one or more parameters which are selected from temperature, humidity, weight, temperature difference, humidity difference, weight difference;
h) when one or more of the parameters reaches a second predetermined threshold, carrying out an additional circulation of the air so as to circulate warm air and/or vapor which are contained in the solar absorber and in the casing, the circulation of the air being carried out in a gap which is defined between the thermal absorber and the casing which is concentric therewith;
i) collecting the water vapor in a condenser which is connected to a tank;
j) carrying out a third measurement of one or more parameters which are selected from temperature, humidity, weight, temperature difference, humidity difference, weight difference;
k) when one or more of the parameters reaches a third predetermined threshold, repeating from a) to j) until obtaining the quantity of water desired.

The present invention, in each of the above-mentioned aspects, and the additional aspects which are mentioned below can also have one or more of the following preferred features.

Preferably, the thermal absorber is completely contained in the casing.

Preferably, the fluid-dynamic communication is carried out through a perforated element which is contained in the thermal absorber and which is positioned in the region of the emission end thereof.

Preferably, the solar receiver comprises a device for the forced circulation of the air, which is positioned between the intake end and the intake valve. The device for the forced circulation of the air is preferably such as to generate a forced air current which is introduced into and/or discharged from the thermal absorber. The valves are selectively actuatable from a closed configuration to an open configuration, and vice versa, so as to selectively and reversibly allow the fluid-dynamic connection between the drying material and the surrounding humid air or between the drying material and the warm air which is contained in the thermal absorber and in the casing so as to enable an adsorption cycle of the humidity by the drying material and a desorption cycle of the water vapor by the drying material.

In the desorption phase, the air contained in the thermal absorber and in the casing is brought to such a temperature that the water contained in the drying material evaporates so that the vapor, preferably the saturated vapor, is the thermovector fluid inside the fluid-dynamic circuit. It will be appreciated that the evaporation temperature is dependent on the pressure inside the solar receiver. It is thereby possible to have an optimized solar receiver which is capable alone of carrying out a plurality of operations, including: concentrating the solar rays on a predetermined point, collecting the ambient humidity by means of a drying material and then releasing it when the drying material and the water contained therein are passed through by warm air which is heated in the casing so as to obtain water vapor formation both by irradiation and by convection.

Advantageously, the solar receiver uses the device for the forced circulation of air to introduce the surrounding humid air into the thermal absorber and to adsorb the water on the drying material and to circulate, preferably with a direction counter to the flow, the warm air which is heated in the casing so as to rapidly desorb the water which is contained in the drying material.

Preferably, the apparatus comprises a pressure sensor near the drying material.

Preferably, the apparatus comprises a humidity sensor near the drying material.

Preferably, the solar receiver comprises an incoming humidity sensor in the region of the intake end and an outgoing humidity sensor in the region of the emission end.

Furthermore, the solar receiver may comprise at least one temperature sensor, for example, a thermocouple, preferably comprising an input temperature sensor in the region of the intake end and an output temperature sensor in the region of the emission end.

The solar receiver may also comprise a load cell which, on the basis of the weight of the receiver, allows identification of the end of an adsorption and desorption phase and therefore allows the passage between one phase and another to be carried out.

Preferably, the condenser is connected to the casing through a non-return valve. The valve which allows, in an open position, the passage of the vapor from the casing to the condenser in the presence of an excess pressure in the casing.

Alternatively, the condenser is connected to an extraction pump which is suitable for extracting the vapor from the casing.

Furthermore, as a result of this technical solution, it is possible to increase the quantity of the water produced per unit of time with respect to the known devices in the prior art.

Despite the thermal receiver being capable of reaching temperatures far greater than 100° C., as a result of the presence of a warm air flow and/or vapor as a thermovector fluid, the desorption of the water from the drying material can be carried out at lower temperatures, preferably of approximately 90°. Alternatively, a desorption phase can be triggered once temperatures of 140° C. have been reached.

Advantageously, the water obtained through the solar receiver is substantially distilled water without any bacteria or other contaminating elements.

In this context, the term “drying material” is intended to indicate a material capable of carrying out a drying process by adsorption. This involves preferable drying materials being materials which are generally hygroscopic and capable of bonding water molecules to themselves in a reversible manner. Preferably, the apparatus also comprises a control unit which is electrically connected to the humidity sensors and the temperature sensors which are capable of processing the signals from the sensors and actuating the valves by opening or closing them in accordance with requirements. Preferably, the control unit is also suitable for moving the support and the solar receiver on the support.

Advantageously, it is thereby possible to position the solar receiver in a more accurate manner by also allowing the desired rotations thereof in accordance with the position of the sun. As a result of this solution, it is possible to further increase the productive output of water.

Preferably, the support is a two-axis follower.

In another aspect, the present invention relates to a method for producing water from ambient humidity which provides for two main phases: an adsorption phase and a desorption phase.

In the adsorption phase, the intake valve and the emission valve are open, the device for the forced circulation of air is activated and the humid air flow is introduced from the intake opening, leaving from the emission opening.

In this manner, the drying material which is arranged inside the thermal absorber adsorbs the humidity up to a saturation state.

Once the saturation of the drying material has been reached, the intake and emission valves are closed and preferably the device for the forced circulation of air is switched off.

In this manner, a fluid-dynamically closed circuit is generated between the thermal absorber and the casing.

Preferably, the fluid-dynamically closed circuit allows the flow of air and vapor as the thermovector fluid of the water with forced recirculation always provided by the device for the forced circulation of the air.

Preferably, the saturation of the drying material is identified by measuring the difference between the humidity value measured by the incoming humidity sensor and the humidity value measured by the outgoing humidity sensor. When the difference is substantially zero, this means that the drying material is saturated.

Alternatively, the saturation point is evaluated using the load cell so that, when a threshold value of the weight of the solar receiver has been exceeded, the absorber material is saturated. The threshold value is suitably defined in a calibration phase of the solar receiver.

Once the adsorption phase is completed, there is carried out the desorption phase which initially provides for heating the thermal absorber up to a predetermined temperature, preferably the evaporation temperature of the adsorbed water on the drying material. Once this temperature has been reached, having measured it with at least the temperature sensor, the device for the forced circulation of air and the preferably saturated vapor which also operates from the thermovector fluid inside the fluid-dynamically closed circuit is activated. Preferably, the air and vapor flow has a direction counter to the flow of the adsorption phase. Preferably, the air and vapor flow passes through the thermal absorber by passing from the emission end to the intake end, through the device for the forced circulation of air which introduces the air at the concentric intake end of the casing. The air saturated with water vapor can condense on the walls of the thermal absorber and the casing by cooling and can be conveyed into a condenser which is connected to the concentric intake end. The partially dehumidified air continues to circulate in the gap which is formed between the walls of the thermal absorber and the casing until re-entering the thermal absorber near the emission end thereof. Alternatively, the saturated vapor can be extracted through the extraction pump or can be introduced into the condenser through the non-return valve.

The desorption phase continues until the drying material is dry. In order to define the end of the desorption phase, it is possible to carry out operations similarly to at the end of the adsorption phase and to use the humidity sensors or by using the load cell. If the load cell is used, if the weight of the solar receiver falls below a previously defined value, this means that the drying material is dry and the desorption phase is concluded.

The alternation between these two phases can continue until the desired water quantity is obtained.

### BRIEF DESCRIPTION OF THE DRAWINGS

The features and advantages of the invention will be better understood from the detailed description of one embodiment which is illustrated by way of non-limiting example with reference to the appended drawings, in which:

FIG. 1 is a schematic illustration of a vapor convection type solar receiver for an apparatus for producing water from atmospheric humidity according to the invention;

FIG. 2 is a sectional side view of the apparatus according to the present invention in a second embodiment;

FIG. 3 is a sectional front view of the apparatus of FIG. 2.

### DETAILED DESCRIPTION OF THE PREFERRED EMBODIMENTS

With reference to the Figures, there is illustrated a preferred embodiment of a convection type solar receiver which is generally designated 1 and which is briefly also called a solar receiver.

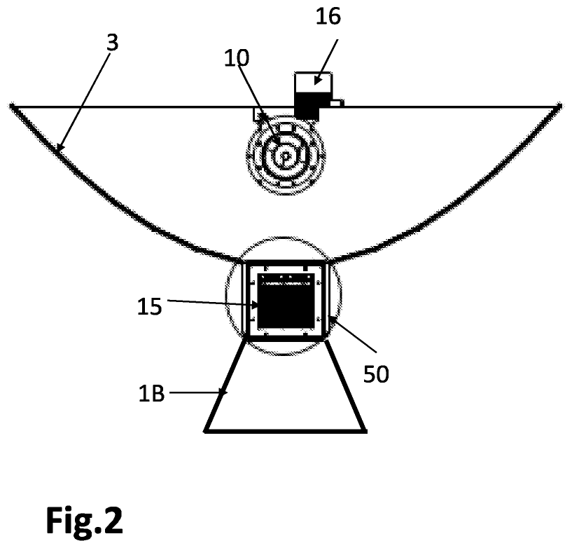

As may be observed in FIG. 2, the solar receiver 1 for producing water from atmospheric humidity is intended to be used in an apparatus 100 for producing water which comprises a frame 1A, which is schematically illustrated in FIG. 2, to which there is fixed a reflective surface 3 which reflects solar radiation. The reflective surface 3 has a focusing axis A for the incident solar radiation.

According to some preferred embodiments of the invention which are illustrated in the Figures, the reflective surface develops in accordance with a parabolic form, which could particularly follow the formula Y=x\hat{ }2/4F, with F being between 300 mm and 500 mm, more preferably F being 400 mm.

The parabolic form optimizes the focusing of the solar rays which are incident on the focusing axis A, reducing the times for reaching the desired temperature.

The solar receiver 1 also comprises a thermal absorber 10 which is substantially positioned in the region of the focusing axis A. The thermal absorber 10 comprises an intake end 12a and an emission end 12b, in addition to the ends 12a, 12b, there are positioned outside the frame an intake valve 13a and an emission valve 13b which connect the thermal absorber 10 to the external environment through an intake opening 13c and an emission opening 13d, respectively.

In order to optimize the absorption of the solar radiation and the reflection of the thermal infrared radiation, the solar absorber 10 may have an opaque coating, in particular it could have a spectrally selective coating, with a high level of absorbance of the solar radiation and high level of reflectance of the thermal infrared radiation. Furthermore, the thermal absorber 10 which is set out in the Figures has a cylindrical form which minimizes the heat losses.

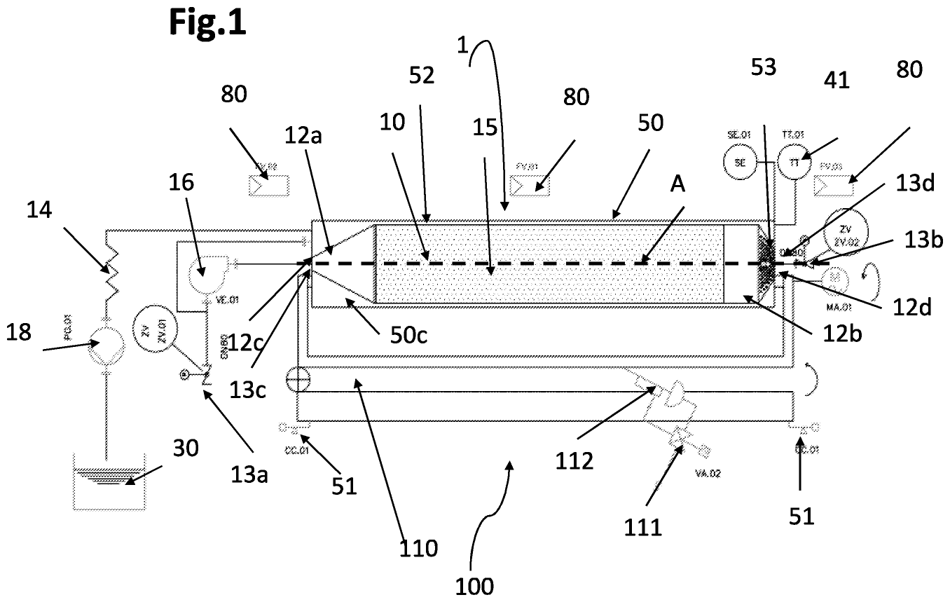

The valves 13a, 13b are selectively able to be actuated between a closed configuration and an open configuration in order to allow the passage of a humid air flow through the thermal absorber 10 and/or through a casing 50 which contains a drying material 15 which is capable of reversibly adsorbing the water which is contained in the humid air. It may be observed that, in some embodiments, the drying material 15 can be received in the thermal absorber 10 which is in turn received in the casing 50, as in the example of FIG. 1. In this case, the casing 50 can be concentric with respect to the thermal absorber and transparent to the solar radiation. An ideal example of humid air being introduced into the solar receiver 1 is night air of desert zones.

The casing 50 preferably extends between the intake end 12a and the emission end 12b.

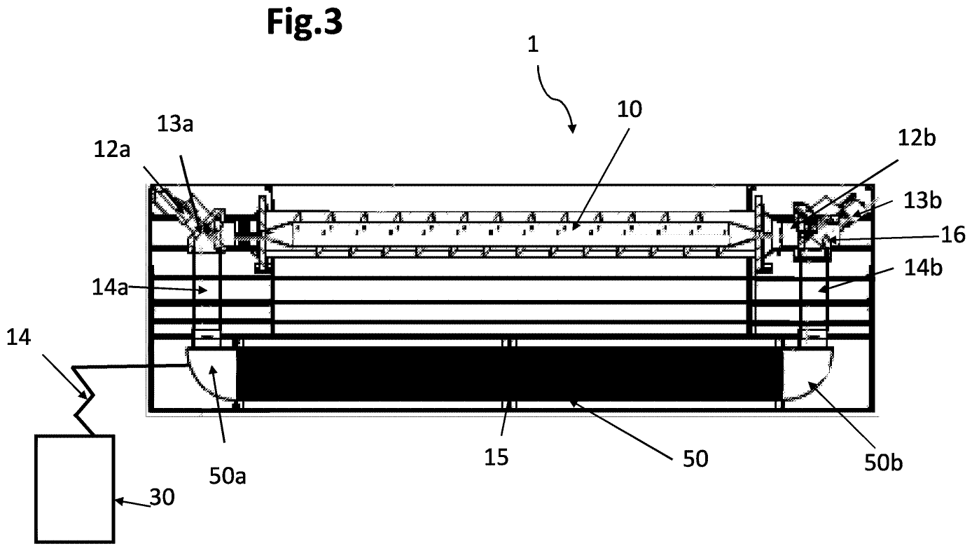

In general terms, the thermal absorber 10 is partially in communication in fluid-dynamic terms with the casing 50. In some embodiments, such as, for example, the one of FIGS. 2 and 3, the casing 50 is arranged outside the concentration zone which is defined by the reflective surface 3, preferably in a position under it. The connection between the thermal absorber 10 and the casing 50 is brought about by means of respective connections 14a, 14b which define a working circuit which is intended for the air and/or vapor circulation, as will be seen in greater detail below.

Alternatively, as previously set out, the thermal absorber 10 may be completely contained in the casing 50 and there is generated between the walls thereof a gap 52 in which the air and vapor can circulate.

Preferably, the casing 50 has an elongate form with a rectangular or square cross-section or may also have a cylindrical form.

Preferably, the solar receiver 1 also comprises a device 16 for the forced circulation of air, preferably a two-directional fan (FIG. 1) which is positioned between the intake end 12a and the intake valve 13a or between the emission end 12b and the emission valve 13b. The device 16 for the forced circulation of air is such as to generate a forced air current which is introduced into or leaves the thermal absorber 10 or, more generally, the above-mentioned working circuit or a portion thereof.

The valves 13a, 13b can be selectively actuated from an open configuration to a closed configuration, and vice versa, so as to allow in a selective and reversible manner the fluid-dynamic connection between the drying material 15 and surrounding humid air which is taken from the external environment, or between the drying material 15 and the warm air by means of the absorber 10 and which is contained in the casing 50, and more generally in the working circuit which is formed thereby, together with the absorber 10, so as to enable an adsorption cycle of the humidity by the drying material 15 and a desorption cycle of the water vapor from the drying material 15.

The solar receiver 1 operates substantially in two phases or cycles, one of adsorption and one of desorption.

In the first phase, typically but not necessarily at night, the humid air is introduced by the device 16 for the forced circulation of air into the thermal absorber 10 and the drying material 15 adsorbs the water which is contained in the air. Preferably, in the adsorption phase, the humid air flow is introduced from the intake opening 12c and is discharged from the emission opening 12d.

In some embodiments, a portion of the air which passes through the thermal absorber 10 finishes in the gap 52 which is generated between the thermal absorber 10 and the casing 50, filling the casing 50 with air.

In general, in this phase the casing is filling with humid air so as to allow the adsorption action.

Once the adsorption phase is finished, there is carried out the desorption phase in which the valves 13a, 13b are closed and the air which is contained in the casing 50 is heated for a variable time by the solar radiation, where applicable reflected by the reflective surface.

There is generated between the thermal absorber 10 and the casing 50 a fluid-dynamically closed circuit which preferably provides for the circulation of the air in a direction counter to that of the adsorption phase. The air passes through the drying material, also transporting the water vapor, and is introduced into the gap 52 in order then to be introduced into the thermal absorber 10 near the emission end 12b, through the perforated element 53.

According to a number of preferred embodiments which are illustrated in FIG. 1, during the recirculation of the air and the saturated vapor inside the fluid-dynamically closed circuit, an extraction pump 18 conveys a portion of the air and the saturated vapor inside a condenser 14 so as to extract the water which is then collected in a tank 30.

In this manner, the water produced is collected and is available for desired treatment steps or methods for use.

The condenser 14 is preferably connected to the casing 50 in the region of a concentric intake end 50a thereof which is where applicable placed in the region of the intake end 12a of the thermal absorber 10.

Alternatively, the condenser 14 is connected to the concentric intake end 50a through a non-return valve which opens by making the vapor flow in the condenser 14 when there is generated a slight excess pressure inside the casing with respect to atmospheric pressure. Preferably, the excess pressure being between 1.5 atm. and 2.5 atm.

According to some preferred embodiments, the condenser 14 is a serpentine member with a helical form.

As a result of this technical solution, it is possible to improve the air passage over the drying material 15 which is contained in the thermal absorber 10 and therefore to improve the output of the water production process.

In fact, there is thereby produced a better circulation of air and the capacity is increased for selectively determining the adsorption and desorption cycles of ambient humidity by the drying material 15.

According to preferred embodiments, the drying material 15 can be silica gel, zeolites, MOF and/or ACF (Activated Carbon Felt made of nonwoven material).

Advantageously, the silica gel is an advantageous compromise between the hygroscopic effect in the adsorption phase and the transfer of water in a desorption phase in terms of the absence of hysteresis and speed of uptake and release of water molecules.

According to a number of embodiments, the drying material 15 is contained in a breathable casing, more preferably in a casing which is made from woven/nonwoven material.

As a result of this technical solution, the drying material is contained inside the thermal absorber 10 in a stable and secure manner having, at the same time, an optimum adsorption and desorption process of water molecules from the air which is passing inside the thermal absorber 10 as a result of the holes present in the breathable material.

According to other embodiments, the casing 50 extends longitudinally and is subdivided transversely to the longitudinal extent from at least one perforated partition wall 17, the perforated partition wall 17 being such as to allow the passage of the air and the water vapor.

According to other embodiments, the casing 50 is subdivided by a plurality of perforated partition walls 17. The plurality of perforated partition walls 17 is suitable for containing and subdividing the drying material 15 in a multi-layered configuration. In this manner, it is possible to arrange homogeneous or increasing quantities of drying material 15 along the casing 50 in accordance with the direction of the humid air flow. In the configuration of increasing quantities of drying material 15, the efficiency of adsorption of the water from the air is maintained substantially constant because, when the percentage of water present in the air decreases, the probability of contact increases between the air and the drying material 15.

According to other embodiments, above the reflective surface the solar receiver 1 comprises a transparent closure surface which is secured to the frame and/or the reflective surface so as to define a closed internal space Si of the solar receiver 1 and the thermal absorber 10 and the casing 50 being contained, at least partially, inside the closed internal space Si.

The closure surface allows the generation of a greenhouse effect inside the closed internal space Si, increasing the heating times of the dry air which is contained in the casing 50 and in the thermal absorber 10.

In order to be able to monitor the humidity and the temperature, the solar receiver 1 may comprise one or more of the following sensors: an incoming humidity sensor, preferably in the region of the intake end 12a, an outgoing humidity sensor, preferably in the region of the emission end 12b, an input temperature sensor, preferably in the region of the intake end 12a, an output temperature sensor, preferably in the region of the emission end 12b. According to a number of preferred embodiments set out in FIG. 1, the

Preferably, the temperature sensors are NTC probes.

The presence of the humidity sensors allows monitoring of the variation of the humidity inside the thermal absorber 10 and therefore allows it to be understood how the evaporation processes are working.

Preferably, in this sense, when the difference of relative humidity which is read between the two humidity sensors is substantially equal to zero, there is a change from the adsorption phase to the desorption phase, or vice versa.

The presence of the temperature sensors serves to measure the temperature inside the thermal absorber 10 and to change to the desorption phase once the process temperature has been reached, which may be between 90° C. and 140° C.

Preferably, the solar receiver 1 comprises at least one load cell 51 which is used to monitor the weight of the solar receiver 1, or of the casing 50 in the embodiments of FIG. 2, so that in the adsorption phase, if a threshold value is exceeded, this means that the drying material 15 is saturated and it is possible to move to the desorption phase. Vice versa, if in the desorption phase the load cell 51 measures a weight less than a threshold value, the drying material 15 is dry and it is possible to change to the adsorption phase.

According to a number of preferred embodiments illustrated in FIG. 1, the solar receiver 10 comprises at least one photovoltaic panel 80 which is fixed to the frame; the photovoltaic panel 80 is constructed and/or subdivided so as to minimize the coverage of the reflective surface. Preferably, the photovoltaic panels 80 are arranged transversely relative to the thermal absorber 10 in the region of the ends 12a, 12b thereof and where applicable longitudinally in the region of the extent of the casing 50 if also arranged in the region of the concentration axis.

It is thereby possible to supply electrical energy to the various electromechanical components of the solar receiver 1 without having a connection to an external electrical line. In other words, this solar receiver 1 becomes a water production system which is independent and autonomous.

The electromechanical components are, for example, the intake valve 13a, the emission valve 13b, the temperature sensors 41, the humidity sensors and the device 16 for the forced ventilation of air.

Alternatively, the photovoltaic panel 80 can be secured to the closure surface.

In this manner, the space used for the photovoltaic panel 80 is optimized, at the same time ensuring an optimum solar exposure thereof and therefore a high electrical output.

With reference to FIG. 1, it may be noted that the solar receiver 1 is connected to a support device 110 which is configured to rotationally secure the solar receiver 1 with respect to a support plane, thereby forming the apparatus 100 for producing water from the atmospheric humidity.

The support 110 may also comprise one or more motors 111 which are necessary for moving the desired components.

Furthermore, even if not visible in the Figures, the support device 110 may contain a control unit which is electrically connected to the humidity sensors and the temperature sensors 41 and which is capable of processing the signals from them. The control unit is also suitable for actuating the valves 13a, 13b by opening or closing them in accordance with requirements.

Finally, it is also electrically connected to the motors 111 and can control the movement of the support 110 and the solar receiver 1 on the support 110 so as to position it in an optimum manner with respect to the position of the sun and therefore by rotating the support 110 and pivoting the solar receiver 1 in order to have the incident solar radiation substantially perpendicular to the focusing axis A.

The motors 111 and the control unit are between the electromechanical components which are supplied electrically by the solar panels 80.

In particular, the support 110 can rotate through 360° and is preferably connected to the solar receiver 1 with a pivot joint and two linear actuators 112 which can move the solar receiver 1 from a horizontal position, parallel with the ground, to a slightly inclined position with respect to the position perpendicular to the ground, and vice versa.

Furthermore, the apparatus 100 may comprise a hydroponic or aeroponic greenhouse (not shown in the Figures) which is connected fluid-dynamically downstream of the tank 30.

In this manner, it becomes not only possible to produce water, but also possible to cultivate plants and vegetables.

The operating methods of the solar receiver 1 and the respective apparatus 100 for producing water from ambient humidity which define the method of the present invention comprise the operations set out below.

In particular, there is preferably provision for an adsorption phase which provides for opening the intake valve 13a and the emission valve 13b and for activating the device 16 for the forced circulation of air so as to introduce the humid air present in the surrounding environment inside the working circuit and to cause it to circulate towards the casing 50 which in turn comprises drying material 15 capable of absorbing the humidity.

The humidity is preferably measured with an incoming humidity sensor and an outgoing humidity sensor which are positioned in the region of an intake end 12a and an emission end 12b of the solar absorber 10, respectively.

When the humidity difference between the incoming humidity sensor and the outgoing humidity sensor is zero, the intake valve 13a and the emission valve 13b are closed and it is possible to switch off the device 16 for the forced circulation of air.

Alternatively, instead of measuring the humidity difference with the humidity sensors, there are used one or more load cells 51 and, once a threshold value imposed by the weight of the solar receiver 1 is exceeded, the valves 13a, 13b are closed.

At this point, the desorption phase starts, in which the air contained in the thermal absorber 10 and where applicable in the casing 50 is heated by means of the reflective surface 3 as a result of the capacity for concentration of the solar rays. In this phase, it is possible to measure the temperature with a temperature sensor being introduced and a temperature sensor being discharged which are positioned in the region of the intake end 12a and the emission end 12b, respectively, alternatively a single temperature sensor 41 will be used.

When the temperature reaches approximately 90°, if it has been switched off, the device 16 for the forced circulation of air is activated so as to circulate the warm air which is contained in the working circuit and particularly in the thermal absorber 10 and in the casing 50 in order to facilitate the desorption of the humidity by the drying material 15. The circulation of the air can take place in a direction counter to the humid air flow provided in the preceding phase.

In the embodiment of FIG. 1, the circulation of the air is carried out between the thermal absorber 10 and the casing 50 which is concentric therewith, which generates a gap in which the water vapor which is contained in the warm air condenses by cooling on at least one wall of the gap and the condensate is conveyed into a condenser 14 which is connected to a tank 30.

In the embodiment of FIGS. 2 and 3, the circulation is carried out between the thermal absorber 10 and the casing 50 by means of the connections 14a, 14b. By measuring the humidity with the incoming humidity sensor and the outgoing humidity sensor when the humidity difference between the two sensors is zero, the desorption phase 51b is concluded and the adsorption and desorption phases are repeated until the desired water quantity is obtained.

Alternatively, instead of measuring the humidity difference with the humidity sensors there are used one or more load cells 51 and, if a value falls below a threshold value imposed by the weight of the solar receiver 1, the valves 13a, 13b are closed.

The control of the adsorption and desorption/condensation phases of the water can be assigned to the control unit which allows the operations to be carried out to be controlled and programmed.

In one embodiment of the above-mentioned method, for example, it is possible for air comprising ambient humidity to be circulated in the thermal absorber 10, and therefore humidity which is absorbed by the drying material, for a time of at least half an hour.

Preferably, the circulation of the air may be carried out for a time greater than an hour.

In this manner, the drying material 15 is placed in the condition of being able to adsorb water molecules therein (if it has not already been saturated). Subsequently, water vapor is evaporated from the drying material 15 for a time which is preferably at least half an hour.

Preferably, all the operations described above are completed in the adsorption and desorption phases of the water in the drying material 15 within an hour.

Advantageously, these operations are repeated a number of times in the course of twenty four hours. This operating method allows the water production to be programmed on a daily basis and therefore allows an expectation of the possibility of predictable and reproducible production to be provided.

Alternatively, for example, it will be possible to program the adsorption and desorption phases so that each one lasts 12 hours.

The end user will have the option of defining the adsorption and desorption phases of the water in accordance with individual specific needs.

The invention carried out according to the embodiments of the present invention allows the production of water, preferably drinking water with a high level of purity and without any bacteria or other contaminating factors.

Furthermore, the above-mentioned invention is suitable for operating correctly in environments having an ambient humidity between 10 and 100%.

1. An apparatus for producing water from ambient humidity, comprising a solar receiver, the solar receiver comprising:
a frame;
a reflective surface which is configured to reflect solar radiation and which is fixed to the frame; the reflective surface having a focusing axis for theincident solar radiation;
a thermal absorber which is transparent to solar radiation and which is positioned substantially in the region of the focusing axis; the thermal absorber;
the apparatus further comprising:
a casing which is in fluid dynamic communication with the thermal absorber so as to generate a working circuit;
an intake valve which connects the casing to the external environment through a respective intake opening which opens from the casing and which is configured to allow the introduction of air from the external environment into the working circuit;
an emission valve which connects the casing to the external environment through a respective emission opening which opens from the casing and which is configured to allow the emission of air from the working circuit;
a condenser which is connected to the casing;
a drying material which is arranged inside the casing;
a device for the forced circulation of air which is connected, in fluid-dynamic terms, to the casing and to the solar absorber, the device for the forced circulation of air being configured so as to generate an incoming air current and/or an outgoing air current into/from the casing;
the intake valve and emission valve being selectively actuatable from an open configuration to a closed configuration, and vice versa, so as to allow in a selective and reversible manner the fluid-dynamic connection between the drying material and surrounding humid air, which is present in the external environment, or between the drying material and warm air and/or vapor which are contained in the working circuit and heated by the thermal absorber so as to carry out an adsorption cycle of the humidity by the drying material and a desorption cycle of water vapor from the drying material, respectively;
wherein the device for the forced circulation of air is configured to operate according to two operating configurations, a first configuration, in which the intake valve and the emission valve are open and the device for the forced circulation of air generates the air current which is introduced into the casing so that there takes place the adsorption cycle of the humidity by the drying material, and a second configuration, in which the valves are closed and the desorption cycle of water vapor by the drying material takes place by means of forced circulation of the warm air and/or the vapor in the working circuit, through the thermal absorber and the drying material, the forced circulation being obtained by means of the device for the forced circulation of air.

2. The apparatus for producing water according to claim 1, wherein the casing is concentric with respect to the solar absorber and which is transparent to solar radiation and the thermal absorber is contained in the casing.

3. The apparatus according to claim 1, wherein the solar receiver is a convection-type solar receiver and wherein the casing extends longitudinally between an intake end and an emission end and contains the drying material, the casing being subdivided, transversely relative to the longitudinal extent thereof, by at least one perforated partition wall, the perforated partition wall permitting passage of the air and water vapor.

4. The apparatus for producing water according to claim 2, wherein the thermal absorber extends longitudinally between a respective intake end and a respective emission end and contains the drying material, the thermal absorber being subdivided, transversely relative to the longitudinal extent thereof, by at least one perforated partition wall, the perforated partition wall permitting passage of the air and water vapor.

5. The apparatus for producing water according to claim 1, further comprising at least one photovoltaic panel which is fixed to the frame, the photovoltaic panel configured to supply electrical energy to electromechanical elements.

6. The apparatus for producing water according to claims claim 1, wherein the thermal absorber has an opaque coating.

7. The apparatus for producing water according to claim 1, wherein the thermal absorber has a spectrally selective coating, with high absorbance of solar radiation and high reflectance of infrared thermal radiation.

8. The apparatus for producing water according to claim 1, further comprising a tank which is connected to the condenser in order to receive the water which is conveyed inside the condenser and which is released as water vapor from the drying material.

9. The apparatus for producing water according to claim 1, further comprising a pump for extracting the vapor which is connected to the condenser.

10. The apparatus for producing water according to claim 1, further comprising at least one sensor selected from: a temperature sensor proximate to the drying material; an input temperature sensor in a region of the intake end; an output temperature sensor in a region of the emission end; a pressure sensor proximate to the drying material; a humidity sensor proximate to the drying material; an incoming humidity sensor in a region of the intake end; an outgoing humidity sensor in a region of the emission end; a load cell; or an optical sensor which is provided to distinguish daylight hours from night-time hours or hours without sunshine.

11.-16. (canceled)

17. The apparatus for producing water according to claim 10, further comprising a support device which is configured to rotationally secure the solar receiver with respect to a support plane.

18. The apparatus for producing water according to claim 17, further comprising a control unit which is electrically connected to the intake valve, the emission valve and the device for the forced circulation so as to selectively carry out the adsorption cycle and the desorption cycle.

19. The apparatus for producing water according to claim 18, further comprising a control unit which is electrically connected to at least one or more of the sensors and capable of processing thesignals coming from the at least one sensor and actuating the valves by opening or closing them in accordance with requirements and activating or deactivating the device for the forced circulation of air.

20. The apparatus for producing water according to claim 18, wherein the control unit is controls motors and/or actuators configured to move the support and the solar receiver on the support.

21. The apparatus for producing water from ambient humidity according to claim 20, further comprising a hydroponic or aeroponic greenhouse device which is connected to the solar receiver.

22. A method for producing water from the ambient humidity by means of an apparatus for producing water according to claim 1, the method comprising:
carrying out a forced air circulation so as to introduce humid air which is present in the surrounding environment inside the drying material suitable for absorbing the humidity;
isolating, in fluid-dynamic terms, the working circuit from the exterior, generating a fluid-dynamically closed circuit between the thermal absorber and the casing;
heating the air which is contained in the thermal absorber and in the casing by means of the reflective surface which is contained in the solar receiver;
carrying out a forced circulation of air inside the working circuit so as to desorb the adsorbed water on the drying material both by conduction, through thetransmission of heat by contact, and by convection, carrying out the forced circulation of air and water vapor as a thermovector fluid;
collecting the water vapor from the fluid-dynamically closed circuit in a condenser which is connected to a tank;
repeating the preceding operations until thea desired water quantity is obtained.

23. AThe method according to claim 22, wherein the apparatus further comprises an optical sensor which is provided to distinguish daylight hours from night-time hours or hours without sunshine, and wherein the method further comprises comprising:
processing the signal of the optical sensor;
if the signal corresponds to daylight hours, changing from the adsorption cycle to the desorption cycle; if the signal corresponds to night-time hours or hours without sunshine, changing from the desorption cycle to the adsorption cycle.

24. AThe method according to claim 23, wherein the apparatus further comprises a load cell and a temperature sensor, and wherein the method further comprises:
carrying out a first measurement of the weight of the apparatus with the load cell;
carrying out forced circulation of the air so as to circulate humid air which is present in the surrounding environment inside the drying material suitable for absorbing humidity;
periodically carrying out a second measurement of the weight of the apparatus until a predetermined threshold is reached;
once the predetermined threshold is reached, processing the signal of the optical sensor;
if the signal corresponds to daylight hours, isolating the apparatus from the exterior in fluid-dynamic terms, generating a fluid-dynamically closed circuit between the thermal absorber and the casing;
interrupting the forced circulation of air;
heating the air which is contained in the thermal absorber and in the casing by means of the reflective surface contained in the solar receiver;
carrying out periodic temperature measurements until a predetermined temperature is reached;
activating the forced circulation of air;
periodically carrying out a third measurement of the weight of the receivers;
desorbing the adsorbed water on the drying material both by conduction, through the transmission of heat by contact, and by convection, carrying out the forced circulation of air and water vapor as a thermovector fluid;
collecting the water vapor from the fluid-dynamically closed circuit in a condenser which is connected to a tank;
when the third measurement reaches the first measurement, interrupting the vapor collection;
repeating the preceding operations until the desired water quantity is obtained.
